(19) United States
(12) Patent Application Publication
(10) Pub. No.: US 2026/0177410 A1
(43) Pub. Date: Jun. 25, 2026

(54) MAGNETIC-INDUCTIVE FLOW MEASUREMENT DEVICE

(71) Applicant: Endress+Hauser Flowtec AG, Reinach (CH)

(72) Inventors: Florent Tschambser, Hesingue (FR); Tulio Paiva Galvao, Schopfheim (DE); Andrew Burg, Basel (CH); Anacelia Weiss, Basel (CH)

(21) Appl. No.: 18/715,314

(22) PCT Filed: Nov. 22, 2022
(86) PCT No.: PCT/EP2022/082696

§ 371 Date: May 31, 2024

(30) Foreign Application Priority Data
Dec. 1, 2021 (DE) 10 2021 131 692.8

(51) Int. Cl. G01F 1/667

(52) U.S. Cl. CPC G01F 1/667; G01F 1/588; G01F 1/60; G01F 25/10

(57) ABSTRACT

A magnetic-inductive flow measurement device for determining a flow rate-dependent measured variable of a flowable medium includes: a device for generating a magnetic field; a device for tapping a measurement voltage induced in the flowable medium; an operating circuit configured to feed electrical power into the field-generating device by an operating signal including a variable coil voltage and a variable coil current and having a time-varying voltage curve divided into time intervals, which each include a first time subinterval in which the coil voltage assumes a first voltage over the first time subinterval; and a control circuit configured to control the first voltage such that a deviation of a control function from a predefined control target value is minimal.

The invention relates to a magnetic-inductive flow measurement device, in particular a magnetic-inductive flowmeter and/or a magnetic-inductive flow measuring probe.

Magnetic-inductive flow measurement devices are used for determining the flow rate and the volumetric flow of a flowing medium in a pipeline. A distinction is made here between in-line magnetic-inductive flowmeters and magnetic-inductive flow measuring probes, which are inserted into a lateral opening of a pipeline. A magnetic-inductive flowmeter has a device for generating a magnetic field, which produces a magnetic field perpendicularly to the flow direction of the flowing medium. Single coils are typically used for this purpose. In order to realize a predominantly homogeneous magnetic field, pole shoes are additionally formed and attached such that the magnetic field lines run over the entire tube cross section substantially perpendicularly to the transverse axis or in parallel to the vertical axis of the measuring tube. In addition, a magnetic-inductive flowmeter has a measuring tube on which the device for generating the magnetic field is arranged. A measuring electrode pair attached to the lateral surface of the measuring tube taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known tube cross section, the volumetric flow can be determined from the induced measurement voltage.

In contrast to a magnetic-inductive flowmeter, which comprises a measuring tube for conducting the medium with an attached device for generating a magnetic field penetrating the measuring tube and with measuring electrodes, magnetic-inductive flow measuring probes are inserted with their usually circular cylindrical housings into a lateral opening of a pipeline and fixed in a fluid-tight manner. A special measuring tube is no longer necessary. The measuring electrode arrangement and coil arrangement, mentioned in the introduction, on the lateral surface of the measuring tube are omitted and are replaced by a device for generating a magnetic field, which device is arranged in the interior of the housing and in direct proximity to the measuring electrodes and is designed such that an axis of symmetry of the magnetic field lines of the produced magnetic field perpendicularly intersects the front face or the face between the measuring electrodes. In the prior art, there is already a plurality of different magnetic-inductive flow measuring probes.

Magnetic-inductive flow measurement devices are often used in process and automation engineering for fluids, starting from an electrical conductivity of approximately 5 μS/cm. Corresponding flow measurement devices are sold by the applicant in a wide variety of embodiments for various fields of application, for example, under the name PROMAG or MAGPHANT.

There is a plurality of different methods for controlling the operating signal applied to the coil arrangement. Generally, they aim at generating a magnetic field with a magnetic induction that is as constant as possible over an entire measurement phase. WO 2014/001026 A1, for example, discloses a controller in which a voltage signal applied to the coil arrangement is controlled in such a way that a coil current flowing through the coil arrangement reaches and maintains a coil current setpoint value in a defined measurement phase. The coil current flowing through the coil arrangement produces a magnetic field with a magnetic induction that depends on the coil current.

DE 10 2015 116 771 B4 also discloses a method for setting a constant magnetic field strength of a magnetic field in a magnetic-inductive flowmeter. In this case, a constant setpoint current is specified for a current controller.

It is basically assumed that by establishing a fixed coil current setpoint value for all time intervals, the magnetic induction of the produced magnetic field also assumes a setpoint value in a reproducible manner. An advantage of such a control is that the control does not require measuring the magnetic induction. However, it has been found that, due to temperature changes and magnetic interference fields, the magnetic field cannot be reproduced solely by adjustment to a fixed coil current setpoint value. As a result, the calibration values assumed for determining the flow-rate-dependent measured variable for magnetic induction differs from the currently present magnetic induction in the measuring tube. Depending on the disturbance variable, this can lead to deviations of up to 20% when determining the flow-rate-dependent measured variable.

The object of the invention is to provide a magnetic-inductive flow measurement device with a more robust magnetic field.

The object is achieved by the magnetic-inductive flow measurement device according to claim 1, the method according to claim 18 and the uses according to claims 30 to 34.

The magnetic-inductive flow measurement device according to the invention for determining a flow-rate-dependent measured variable of a flowable medium comprises:
a device for generating a magnetic field, in particular comprising a coil arrangement;
a device for tapping off a measurement voltage induced in the flowable medium, in particular comprising two preferably diametrically arranged measurement electrodes;
an operating circuit which is configured to feed electrical power into the device for generating the magnetic field by means of an electrical operating signal having a variable (coil) voltage and a variable (coil) current,
   wherein the operating signal has a voltage curve which is variable over time and which is divided into time intervals,
   wherein the time intervals each have a first time subinterval in which the (coil) voltage assumes a first (coil) voltage, which is in particular constant over the, in particular entire, first time subinterval; and
a controller circuit, in particular having a microprocessor,
   wherein the controller circuit is configured to control at least the first (coil) voltage in such a way that a difference between a control function and a predetermined control setpoint value, in particular comprising a variable proportional to a magnetic flux, is minimal.

The method according to the invention for operating a magnetic-inductive flow measurement device for determining a flow-rate-dependent measured variable of a flowable medium, wherein the magnetic-inductive flow measurement device comprises a device for generating a magnetic field and a device for tapping off a measurement voltage in the medium, comprising the method steps of:
applying an operating signal having a variable (coil) voltage and a variable (coil) current to the device for generating the magnetic field for feeding electrical power into the device for generating the magnetic field,
   wherein the operating signal has a voltage curve which is variable over time and which is divided into time intervals,
   wherein the time intervals each have a first time subinterval, in which a first (coil) voltage, which is in particular constant over the, in particular entire, first time subinterval, is applied to the device for generating the magnetic field;
controlling the first (coil) voltage in such a way that a difference between a control function and the control setpoint value is minimal.

Magnetic-inductive flow measurement devices having this type of controller circuit are more resistant to external interference fields. The controller circuit according to the invention is particularly advantageous for use in magnetic-inductive flow measurement devices supplied via an electrochemical accumulator. They are usually operated with a significantly lower current or a significantly lower (coil) voltage than conventional magnetic-inductive flow measurement devices that are supplied via a power supply. This means that the field-conducting components do not go into magnetic saturation during use. As a result, in addition to a particularly increased sensitivity to external interference fields, they also have an extended settling time during startup, wherein the settling time describes the period to be waited after the flow measurement device has been switched on until the device for generating the magnetic field is warmed up and in which the magnetic induction continuously settles toward the setpoint value. Magnetic-inductive flow measurement devices having the controller circuit according to the invention also have a significantly lower temperature coefficient of the magnetic field, wherein the temperature coefficient describes the difference of the magnetic field for each temperature change.

The control setpoint value determined and provided at the factory or during startup can be determined in an adjustment process or by computer simulation. The control setpoint value also comprises a variable which is proportional to the magnetic flux. This means that the setpoint value comprises the unit of one of the magnetic fluxes. The magnetic flux of a coil arrangement depends on the one hand on the self-induction L of the coil and a quadratic contribution of the (coil) current currently flowing through the coil arrangement, and on the other hand on the magnetic flux generated by eddy currents occurring in the metal carrier tube and the housing. If an external magnet is attached or brought close to the magnetic-inductive flow measurement device, it also contributes to the magnetic flux in the measuring tube.

Advantageous embodiments of the invention are the subject matter of the dependent claims.

One embodiment provides for the time intervals to each have a second time subinterval in which a second (coil) voltage, which is in particular constant over the, in particular entire, second time subinterval, is applied to the device for generating the magnetic field,
wherein the second (coil) voltage is greater than the first (coil) voltage,
wherein the duration of the second time subinterval and the first (coil) voltage are each a changing and controllable variable,
wherein the control function depends on a product of the duration of the second time subinterval and a function dependent on the first (coil) voltage.

The advantage of this embodiment is that the measurement intervals, in which the coil current has settled and assumes a coil current value which substantially no longer changes over time, start much earlier as a result.

One embodiment provides for an absolute value of a quotient of the first (coil) voltage and the second (coil) voltage to be constant over the voltage curve,
wherein the function dependent on the first (coil) voltage is inversely proportional to the duration of the second time subinterval.

The advantage of this design is that it realizes a control which ensures a robust magnetic field and at the same time reacts very quickly to the influences of external magnetic fields.
One embodiment provides for an absolute value of the second (coil) voltage to be constant over the time intervals.
One embodiment provides for the (coil) coil current to assume in each case a maximum coil current value in the time intervals, in particular in the first time subinterval,
wherein the condition is fulfilled that one of a quotient of the maximum coil current value and a coil current value determined during the first time subinterval is constant over the operating signal.

By determining the quotient of the first (coil) voltage and the second (coil) voltage, a simplified control results. A reduction in sensitivity to interference fields and temperature influences was possible to achieve by determining, as an operating signal parameter, the function dependent on the product of the duration of the second time subinterval and on the first (coil) voltage. A magnetic-inductive flow measurement device having particularly high insensitivity and fast reaction time was possible to achieve in particular by controlling the variable and controllable duration of the second time subinterval and of the first (coil) voltage or of the function dependent on the first (coil) voltage such that the product between the two parameters assumes a control setpoint value. In addition, continuous monitoring of the apparent self-induction of the magnetic-inductive flow measurement device is not necessary. It has been found that as a result of the embodiment according to the invention, in which the function dependent on the product of the duration of the second time subinterval and on the first (coil) voltage is kept constant, the function dependent on the self-induction value of the apparent self-induction and on the coil current value of the (coil) current or its product remains constant as well. Since the quotient of the first (coil) voltage and second (coil) voltage is constant, the function dependent on the first (coil) voltage is to be equated with a function dependent on the second (coil) voltage.

The controller circuit is configured to control the duration of the second time subinterval such that at a defined point in time, for example, the beginning of the measurement interval in which the induced measurement voltage is determined, or in a time segment the difference between a test variable and a test setpoint value is minimal. The test variable can be a measured value of the (coil) current, a sum or an integral over a course of the (coil) current or a function dependent on the coil current. The test setpoint value for the different time subintervals can vary. Alternatively, the controller circuit can be designed and configured to control the duration of the second time subinterval such that a duration of the (coil) current settling after the beginning of the first time subinterval is minimal.
One embodiment provides for the (coil) current to assume in each case a maximum coil current value in the time intervals, in particular in the first time subinterval,
wherein the function dependent on the first (coil) voltage also depends on the maximum coil current value.
One embodiment provides for the function dependent on the first (coil) voltage to also depend on ln ((Uₛₕₒₜ+U_{hold})/(Uₛₕₒₜ-U_{hold})), in particular be proportional thereto.

The second (coil) voltage can be selected to be constant or at a constant ratio to the first (coil) voltage. According to a preferred embodiment, however, the second (coil) voltage is a controllable variable. For example, the second (coil) voltage may be controlled such that the duration of the second time subinterval is as small as possible, i.e., the duration until the magnetic field assumes a steady state is as short as possible.
In one embodiment, the control function depends on a product of the duration of a rise time subinterval and a function dependent on the first (coil) voltage,
wherein an absolute value of the (coil) current rises from a first coil current setpoint value to a second coil current setpoint value within the rise time subinterval. 2
One embodiment provides for the (coil) current to assume in each case a maximum coil current value in the time intervals, in particular in the first time subinterval,
wherein the control function depends on a product of the duration of a third time subinterval and a function dependent on the first (coil) voltage,
wherein the third time subinterval is limited by the start of the second time subinterval and a point in time at which the (coil) current assumes the maximum coil current value.
One embodiment provides for a sign of the voltage curve to alternate in consecutive time intervals.
One embodiment provides for time intervals with a positive sign in the voltage curve to have a first control setpoint value and time intervals with a negative sign to have a second control setpoint value,
wherein the first control setpoint differs from the second control setpoint.
One embodiment provides for the control function to depend on a product of a coil current value of the (coil) current during the measurement interval and an apparent self-inductance.

The apparent self-inductance of the magnetic-inductive flow measurement device can be determined, for example, from the gradient of the (coil) current around the coil current zero point. In this case, the electrical resistance is approximately zero, and thermal influences are negligibly small. In order to avoid eddy current effects, the apparent self-inductance can be determined in a time segment in which the coil current overshoots due to the switchover or change of the coil voltage and then decreases. During the overshoot, the temporal change in eddy currents is low. Alternatively, the apparent self-inductance can also be determined as a function of the time curve of the (coil) current and the coil voltage. A measuring circuit can be provided to determine the apparent self-inductance. The apparent self-inductance is made up of the self-inductance of the device for generating the magnetic field, the effects of eddy currents in the metal measuring tube and metal housing, if present in each case, and the effects of external magnetic fields.
One embodiment provides for the magnetic-inductive flow measurement device to be designed as a magnetic-inductive flowmeter, comprising a measuring tube for conducting the flowable medium.
One embodiment provides for the magnetic-inductive flow measurement device to be designed as a magnetic-inductive flow measuring probe to be introduced into a lateral opening of a pipeline, comprising a housing to be supplied with the medium.
In one embodiment, the coil current is less than or equal to 750 mA, in particular less than or equal to 350 mA and preferably less than or equal to 30 mA.
One embodiment provides for the operating circuit to be powered by means of a galvanic cell, in particular by means of a battery.
The use of a magnetic-inductive flow measurement device according to the invention takes place in applications with OIML R-49 (2013), EN1434-4:2018 (2018) or DIRECTIVE 2014/32/EU (2014) requirements.
One embodiment provides for the magnetic-inductive flow measurement device to have a housing which has a plastics or aluminum casing or to be formed exclusively by a plastics housing body.
The magnetic-inductive flow measurement device according to the invention is used in applications in which the magnetic-inductive flow measurement device is exposed to a magnetic field of greater than or equal to 0.3 G, in particular between 1.25 and 90 G, in particular for process monitoring of a smelting furnace or a desalination plant.
The use according to the invention of a plurality of the magnetic-inductive flow measuring devices takes place in a rotary carousel filling machine.

One embodiment provides for the magnetic-inductive flow measurement device or the plurality of magnetic-inductive flow measurement devices in each case not to have a shielding plate within a housing and/or to be arranged without shielding with respect to an external magnetic field generating device.
In one embodiment, 1≤t_{hold}≤2000 ms, in particular 5≤t_{hold}≤1000 ms.
In one embodiment, 0.1≤tₛₕₒₜ≤500 ms, in particular 0.1≤t_{hold}≤300 ms.
In one embodiment, 1≤Uₛₕₒₜ≤230 V, in particular 3.6≤Uₛₕₒₜ≤60 V.
In one embodiment, 0.1≤U_{hold}≤23 V, in particular 0.5≤U_{hold}≤20 V.
In one embodiment, 5≤I≤2000 mA, in particular 10≤/≤500 mA.
One embodiment provides for the control setpoint value to assume a value between 0.01 and 10 Wb.
One embodiment provides for the first time subinterval to follow the second time subinterval in the voltage curve.
One embodiment provides for coil currents of different measurement intervals to be changing variables or coil current values of different measurement intervals to differ from each other.

The invention is explained in greater detail with reference to the following figures. In the figures:

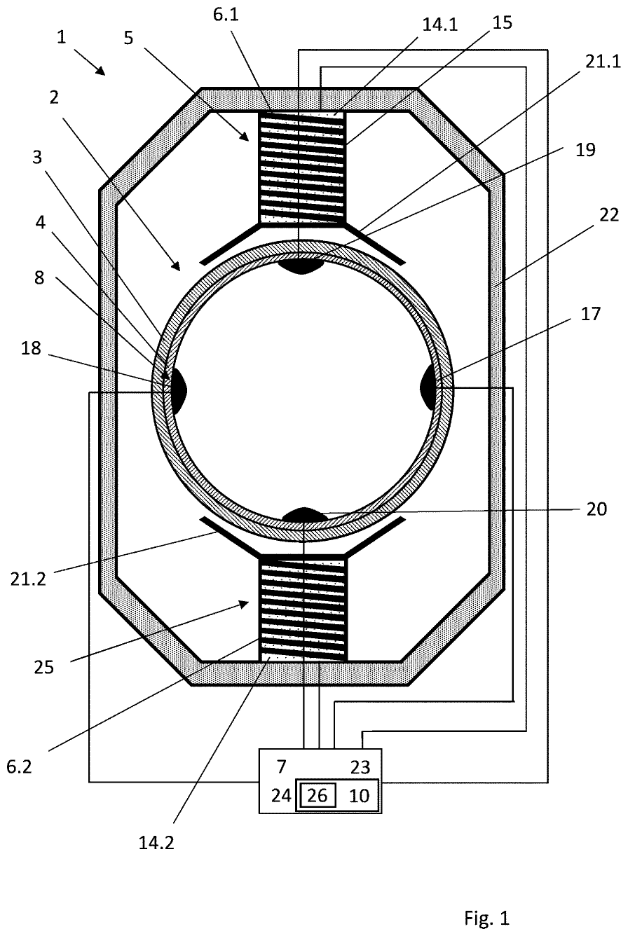

FIG. 1: shows an embodiment of a magnetic-inductive flow measurement device according to the invention;

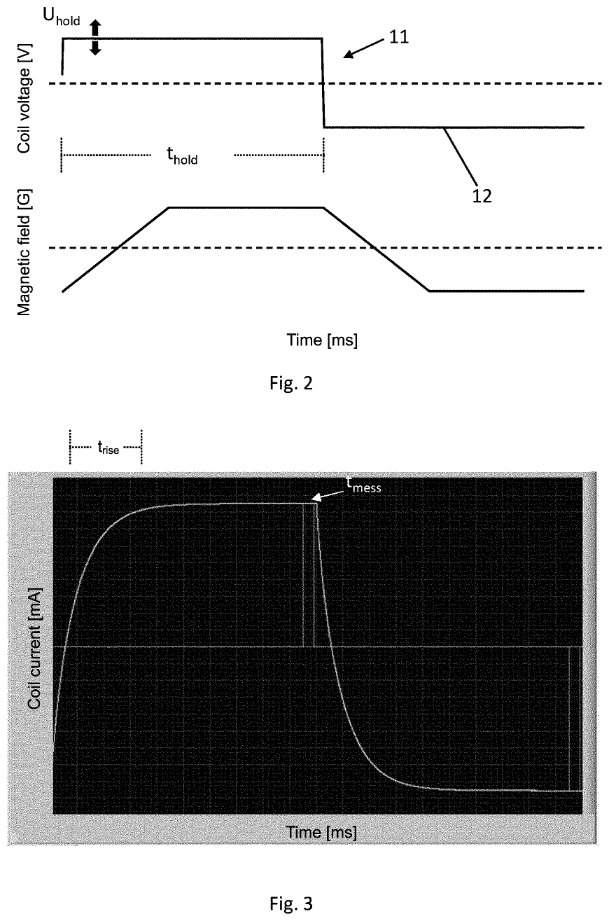

FIG. 2: shows a first embodiment of the course of the (coil) voltage and the correspondingly produced magnetic field through the coil arrangement;

FIG. 3: shows a first embodiment of the curve of the current flowing through the coil arrangement;

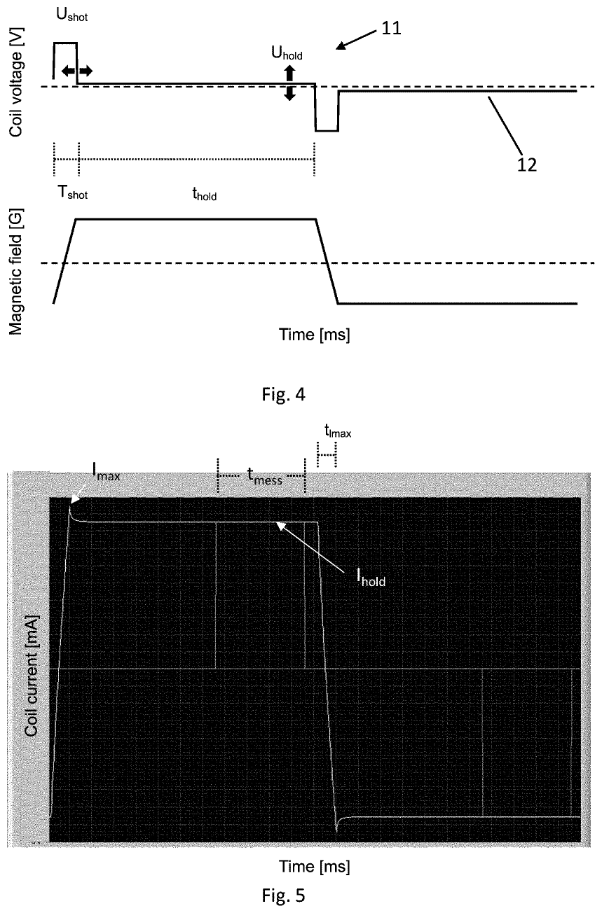

FIG. 4: shows a second embodiment of the curve of the (coil) voltage and the correspondingly produced magnetic field through the coil arrangement;

FIG. 5: shows a second embodiment of the curve of the (coil) current flowing through the coil arrangement;

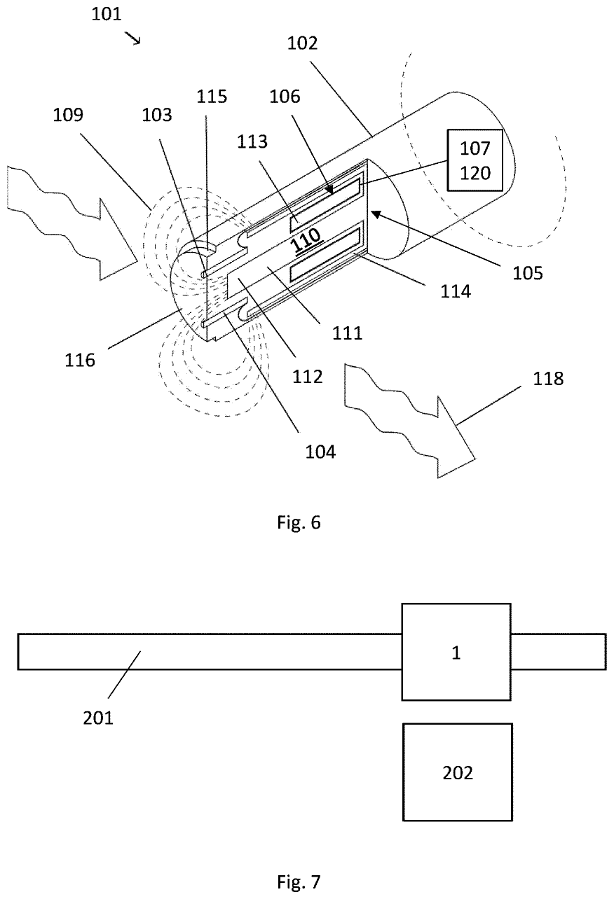

FIG. 6: is a perspective view of a partially sectioned embodiment of a magneto-inductive flow measuring probe according to the invention;

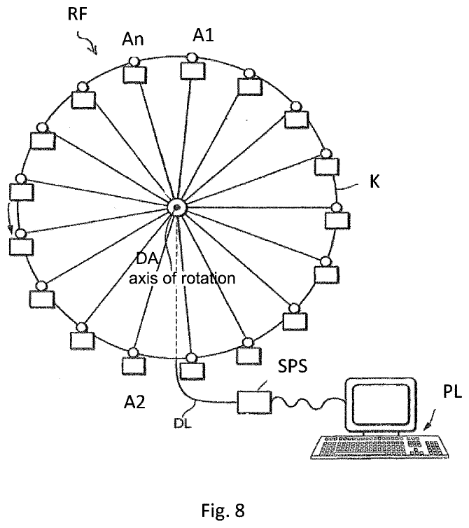

FIG. 7: is a schematic representation of a measuring arrangement with a magnetic-inductive flow measurement device according to the invention;

FIG. 8: is a schematic top view of a carousel filling machine with magnetic-inductive flow measuring devices according to the invention; and

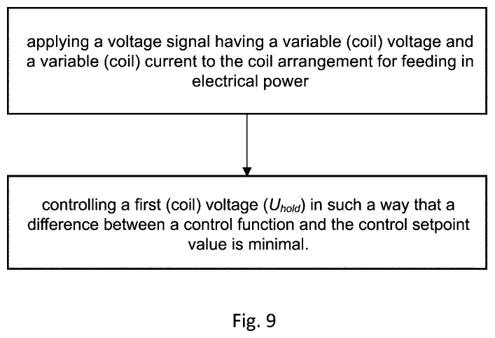

FIG. 9: is a representation of an embodiment of the method sequence.

FIG. 1 shows a cross section of an embodiment of the magneto-inductive flow meter 1 according to the invention. The structure and measuring principle of a magneto-inductive flow meter 1 are known in principle. A flowable medium having an electrical conductivity is conducted through a measuring tube 2. The measuring tube 2 comprises a carrier tube 3, which is usually formed of, or at least comprises, steel, ceramic, plastic or glass. A device 5 for generating a magnetic field is arranged on the carrier tube 3 such that the magnetic field lines are oriented substantially perpendicularly to a longitudinal direction defined by the measuring tube axis. The device 5 for generating the magnetic field comprises a coil arrangement consisting of at least one saddle coil or at least one coil 6. Magnetic-inductive flowmeters usually have two diametrically arranged coils 6. A coil core 14 usually extends through a receptacle 15 of the coil 6. The receptacle 15 is understood to mean the volume limited by the coil wire forming the coil 6. The receptacle 15 of the coil 6 can thus be formed by a coil holder or by the imaginary enclosed volume. The latter occurs when the coil wire of the coil 6 is wound directly around the coil core 14. The coil core 14 is formed from a magnetically conductive, in particular soft magnetic material. The device 5 for generating the magnetic field usually also comprises a pole shoe 21 which is arranged at one end of the coil core 14. The pole shoe 21 can be a separate component or can be monolithically connected to the coil core 14. In the depicted embodiment of FIG. 1, two diametrically arranged coils 6.1, 6.2 each have a coil core 14.1, 14.2 and a pole shoe 21.1, 21.2. The two coil cores 14.1, 14.2 are connected to one another via a field return 22. The field return 22 connects the sides of the coil cores 14.1, 14.2 facing away from one another in each case. However, magnetic-inductive flow measurement devices having exactly one coil having a coil core or a saddle coil and without a field return are also known. The device 5 for generating a magnetic field, in particular the coil 6, is connected to an operating circuit 7, which operates the coil 6 with an operating signal 11. The operating signal 11 can be a (coil) voltage with a time-varying voltage curve and is characterized by operating signal parameters, wherein at least one of the operating signal parameters is controllable. The magnetic field built up by the device 5 for generating the magnetic field is produced by a (coil) voltage of alternating polarity clocked by means of an operating circuit 7. This ensures a stable zero point and makes the measurement insensitive to influences due to electrochemical disturbances. The two coils 6.1, 6.2 can be connected separately to the operating circuit 7 or connected in series or parallel to one another.

When the magnetic field is applied, a flow-dependent potential distribution results in the measuring tube 2, which potential distribution can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measured electrodes 17, 18 to form a galvanic contact with the medium. However, what is also known are magnetic-inductive flow meters which comprise measuring electrodes arranged on the outer wall of the carrier tube 3 that are not in contact with a medium. The measuring electrodes 17, 18 are generally arranged diametrically and form an electrode axis, or are intersected by a transverse axis which runs perpendicularly to the magnetic field lines and the longitudinal axis of the measuring tube 2. However, what is also known are devices 8 for tapping off the induced measurement voltage which have more than two measurement electrodes. The flow-rate-dependent measured variable can be determined on the basis of the measured measurement voltage. The flow-rate-dependent measured variable comprises the flow rate, the volume flow, and/or the mass flow of the medium. A measuring circuit 8 is configured to detect the induced measurement voltage applied to the measurement electrodes 17, 18, and an evaluation circuit 24 is designed to determine the flow-rate-dependent measured variable.

The carrier tube 3 is often formed from an electrically conductive material, such as steel. In order to prevent the measurement voltage applied to the first and second measuring electrodes 2, 3 from being conducted away via the carrier tube 3, the inner wall is lined with an insulating material, for example, a (plastics) liner 4.

Commercially available magnetic-inductive flowmeters have two further electrodes 19, 20 in addition to measuring electrodes 17, 18. For one thing, a fill-level monitoring electrode 19 attached ideally at the highest point in the measuring tube 2 serves to detect partial filling of the measuring tube 1 and is configured to pass this information to the user and/or to take into account the fill level when determining the volume flow. Furthermore, a reference electrode 20, which is usually attached diametrically to the fill-level monitoring electrode 19 or at the lowest point of the measuring tube cross section, serves to establish a controlled electric potential in the medium. Generally, the reference electrode 20 is used to connect the flowing medium to a ground potential.

The operating circuit 7, controller circuit 10, measuring circuit 23 and evaluation circuit can be part of a single electronic circuit or can form individual circuits. At least the controller circuit 10 has a microprocessor, in particular a programmable microprocessor 26, i.e., a processor designed as an integrated circuit. Said microprocessor is configured to adjust the voltages and the duration of the time subintervals and to change them so that the specification for the control function is fulfilled.

The operating circuit 7 is configured to apply a first (coil) voltage to the device 5 for generating the magnetic field for a first time subinterval. According to an advantageous embodiment, the time intervals also each have a second time subinterval, in which a second (coil) voltage, which is in particular constant over the, in particular entire, second time subinterval, is applied to the device 5 for generating the magnetic field; a second (coil) voltage is also to be applied to the coil arrangement for a second time subinterval. The second (coil) voltage is greater than the first (coil) voltage. In addition, in a single time interval, the first time subinterval follows the second time subinterval. The duration of the first time subinterval is greater than the duration of the second time subinterval. The duration of the second time subinterval is a controllable variable. The same applies to the first (coil) voltage. FIGS. 2 and 5 show possible embodiments of the operating signal.

According to the invention, the controller circuit 10 is configured to control one of the operating signal parameters of the operating signal, in particular at least the first (coil) voltage (U_{hold}), in such a way that a difference between a control function and a predetermined control setpoint value, in particular comprising a variable proportional to a magnetic flux, is minimal. The control function can depend on a product of the duration of the second time subinterval and a function dependent on the first (coil) voltage. For this purpose, the first (coil) voltage and the duration of the second time subinterval are controlled such that a variable dependent on the first (coil) voltage and on the duration of the second time subinterval does not differ from the control setpoint value. In case of a difference, due to magnetic interference fields or temperature influences, the two control parameters are adjusted until the difference between the product and the control setpoint value is minimal again.

FIG. 2 shows a first embodiment of the operating signal and the correspondingly produced magnetic field through the coil. According to the invention, the operating signal comprises a (coil) voltage with a time-variable curve 12 which is divided into time intervals t. The sign of the applied (coil) voltage changes in successive time intervals t. The operating signal shown in FIG. 2 comprises time intervals t, each having a first time subinterval t_{hold} in which a constant first (coil) voltage U_{hold} is applied to the coil over the entire duration of the first time subinterval t_{hold}. The detected measurement voltage induced for determining the flow-rate-dependent measured variable is determined in the first time subinterval t_{hold}, in particular during a measurement interval. During the measurement interval, a coil current flows through the device 5 for generating the magnetic field. Said coil current is not constantly controlled, i.e., an absolute value of a (coil) current flowing during the measurement interval is a changing variable in different time intervals t. According to the first embodiment, the controller circuit 10 is configured to control the first (coil) voltage U_{hold} of a time interval t in such a way that a difference between a control function and a predetermined control setpoint value, in particular comprising a variable proportional to a magnetic flux, is minimal. According to the invention, the first (coil) voltage U_{hold} is a time-varying and controllable variable. The rise in the coil current is characterized by a duration of a time subinterval tᵣᵢₛₑ which can be determined via a measuring circuit. An absolute value of the (coil) current rises from a first coil current setpoint value to a second coil current setpoint value within the time subinterval tᵣᵢₛₑ. The first (coil) voltage U_{hold} is controlled in such a way that a variable dependent on the product of the duration of the time subinterval tᵣᵢₛₑ and the first (coil) voltage U_{hold} does not differ from a specified second setpoint value.

FIG. 3 shows a time curve of the (coil) current resulting from the voltage signal in FIG. 2. After switching the applied (coil) voltage, the direction of flow of the (coil) current changes. Within a rise time subinterval tᵣᵢₛₑ, the absolute value of the (coil) current rises with a non-linear behavior. The coil current approaches a maximum coil current value Iₘₐₓ. When the coil current is maximal and substantially no longer changes, the measurement interval tₘₑₛₛbegins. Only measurement voltages determined in this time interval are included in the determination of the flow-rate-dependent variable.

FIG. 4 shows a second embodiment of the operating signal and the produced magnetic field through the device for generating the magnetic field. According to the invention, the operating signal comprises a (coil) voltage with a time-variable curve 12 which is divided into time intervals t. The sign of the applied (coil) voltage changes in successive time intervals t. The operating signal shown in FIG. 4 comprises time intervals t, each having a first time subinterval t_{hold} in which a constant first (coil) voltage U_{hold} is applied to the coil over the entire duration of the first time subinterval t_{hold}. The detected measurement voltage induced for determining the flow-rate-dependent measured variable is determined in the first time subinterval t_{hold}. In addition, the time intervals t each have a second time subinterval tₛₕₒₜ in which a second (coil) voltage Uₛₕₒₜ, which is in particular constant over the entire duration of the second time subinterval tₛₕₒₜ is applied to the coil. In this case, the second (coil) voltage Uₛₕₒₜ is greater than the first (coil) voltage U_{hold}. In the voltage curve, the first time subinterval t_{hold} follows the second time subinterval tₛₕₒₜ. In addition, the duration of the second time subinterval tₛₕₒₜ is shorter than the duration of the first time subinterval t_{hold}. The duration of the second time subinterval tₛₕₒₜ is time-varying and controllable. The same applies to the first (coil) voltage U_{hold}. At least the first (coil) voltage U_{hold} is controlled in such a way that a difference between a control function and a predetermined control setpoint value, in particular a control setpoint value proportional to a magnetic flux, is minimal. In this case, the control function depends on a product of the duration of the second time subinterval tₛₕₒₜ and a function dependent on the first (coil) voltage U_{hold}. The control setpoint value can be predetermined for the entire voltage curve and therefore for all time intervals. Alternatively, time intervals with a positive sign in the voltage curve can have a first control setpoint value and time intervals with a negative sign can have a second control setpoint value, wherein the first control setpoint value differs from the second control setpoint value.

The first (coil) voltage U_{hold} and the second (coil) voltage Uₛₕₒₜ can be set such that a ratio between the first (coil) voltage U_{hold} and the second (coil) voltage Uₛₕₒₜ is constant over the entire voltage curve 12 or an absolute value of a quotient of the first (coil) voltage U_{hold} and the second (coil) voltage Uₛₕₒₜ is constant over the voltage curve 12. This means that when controlling the first (coil) voltage U_{hold}, the second (coil) voltage Uₛₕₒₜ is also automatically adjusted proportional to change. In this case, the function dependent on the first (coil) voltage U_{hold} is preferably inversely proportional to the duration of the second time subinterval tₛₕₒₜ. Alternatively, the second (coil) voltage Uₛₕₒₜ or an absolute value of the second (coil) voltage Uₛₕₒₜ can assume a constant value over the entire voltage curve 12.

In addition to controlling the first (coil) voltage U_{hold}, the duration of the second time subinterval tₛₕₒₜ is controlled in such a way that a determined value of a variable dependent on a test variable assumes a test setpoint value within the duration of the second time subinterval tₛₕₒₜ. An example of such an implementation is disclosed in WO 2014/001026 A1. The variable can be, for example, a coil current setpoint value, a sum or an integral of the measured values of the test variable for a predefined time segment. In this case, the two control parameters are controlled in such a way that a function dependent on the product of the first (coil) voltage U_{hold} and the duration of the second time subinterval tₛₕₒₜ does not differ from a predetermined second control setpoint value. The function dependent on the first (coil) voltage U_{hold} is inversely proportional to the duration of the second time subinterval tₛₕₒₜ. The test variable May be a measured value of the (coil) current, a time curve of a (coil) current, and/or a variable dependent thereon.

The controller circuit is configured to, if a coil test current value or a test variable dependent on the coil test current value differs from a setpoint value in a time interval t_{N}, change the duration of the second time subinterval tₛₕₒₜ such that the difference is smaller in a temporally subsequent time interval t_{N+M}, wherein M≥1. At the same time, the controller circuit is configured to, if the actual value differs from a setpoint value in a time interval ty, change the first (coil) voltage U_{hold} such that the difference between a setpoint value is smaller in a temporally subsequent time interval t_{N+M}, wherein M≥1. However, at least one of the conditions listed above must be met. The controller circuit can be configured to control further variables and/or functions.

The control function, in particular the function dependent on the first (coil) voltage U_{hold}, can also depend on ln ((Uₛₕₒₜ+U_{hold})/(Uₛₕₒₜ-U_{hold})) or be proportional thereto.

FIG. 5 shows a time curve of the (coil) current through the device for generating the magnetic field, in particular through the coil arrangement, resulting from the voltage signal in FIG. 4. The coil current changes the direction of flow in the individual time intervals. By applying the second coil voltage, which is many times higher than the first (coil) voltage, the coil current increases rapidly. From the beginning of the first time subinterval, the coil current continues to increase until it reaches the maximum coil current value Iₘₐₓ. In this time subinterval, the eddy currents are substantially constant. The coil current then decreases and converges towards a substantially constant coil current value I_{hold}.

According to a further embodiment, a measuring circuit is configured to determine, in the first time subinterval t_{hold}, a maximum coil current value Iₘₐₓ, and the duration of the second time subinterval tₛₕₒₜ and the function dependent on the first (coil) voltage U_{hold} are controlled such that a control function does not differ from a predetermined second setpoint value, wherein the control function depends on a product of the duration of the second time subinterval tₛₕₒₜ and the function dependent on the first (coil) voltage U_{hold} and the maximum coil current value Iₘₐₓ.

Alternatively, the controller circuit can be configured to control at least one of the operating signal parameters-preferably the first (coil) voltage U_{hold}-in such a way that one of a quotient of the maximum coil current value Iₘₐₓ and a coil current value I_{hold} determined during the first time subinterval t_{hold} is constant over the operating signal.

According to one embodiment, the control function can depend on a product of the duration of a third time subinterval t_{Imax} and a function dependent on the first (coil) voltage U_{hold}. The third time subinterval t_{Imax} is limited by the start of the second time subinterval tₛₕₒₜ and a point in time at which the coil current assumes the maximum coil current value Iₘₐₓ.

The two curves shown in FIG. 2 to FIG. 5 are highly simplified schemes. The magnetic field settles generally after the second time subinterval.

First, the measuring principle on which the invention is based is explained on the basis of the perspective and partially sectional illustration of FIG. 6. A flow measuring probe 101 comprises a generally circular cylindrical housing 102 having a predefined outer diameter. Said housing is adapted to the diameter of a bore, which is located in a wall of a tube line (not shown in FIG. 6) into which the flow measuring probe 101 is inserted in a fluid-tight manner. A medium to be measured flows in the tube line, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a coil arrangement 106 arranged in the housing 102, a magnetic field 109 that extends through the end portion into the medium can be produced. A coil core 111, which at least partially consists of a soft magnetic material and is arranged in the housing 102, terminates at or near the end portion 116. A field return body 114 that surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. A first and a second measuring electrode 103, 104 forming a galvanic contact with the medium to be conducted form the device for detecting a measurement voltage induced in the medium and are arranged in the front body 115 and, like the outer walls of the housing, touch the medium. An electrical (coil) voltage induced due to Faraday's law of induction can be tapped off at the measuring electrodes 103, 104 by means of a measurement and/or evaluation unit. This is at a maximum if the flow measuring probe 101 is installed in the pipeline such that a plane spanned by a straight line intersecting the two measuring electrodes 103, 104 and by a longitudinal axis of the flow measuring probe runs perpendicularly to the flow direction or to the longitudinal axis of the tube line. An operating circuit 107 is electrically connected to the coil arrangement 106, in particular to the coil 113, and is configured to impress a clocked operating signal to the coil 113 in order to thus produce a clocked magnetic field 109. The controller circuit 120 is configured to control at least one of the operating signal parameters of the operating signal, in particular the first (coil) voltage and preferably also the duration of the second time subinterval, in such a way that a difference between a control function and a predetermined control setpoint value, in particular comprising a variable proportional to a magnetic flux, is minimal. According to an advantageous embodiment, the function dependent on the first (coil) voltage U_{hold} and the duration of the second time subinterval tₛₕₒₜ are controlled in such a way that both are inversely proportional to each other.

FIG. 7 is a schematic representation of a measuring arrangement with a magnetic-inductive flow measurement device according to the invention, in particular a magnetic-inductive flowmeter 1, which is arranged in a pipeline 201. The measuring arrangement comprises a magnetic field generating device 202 which produces an external interference magnetic field to which the magnetic-inductive flowmeter is exposed. The magnetic field generating device 202 can comprise a smelting furnace or a desalination plant.

FIG. 8 is a schematic top view of a carousel filling machine RF with a plurality of magnetic-inductive flow measurement devices according to the invention for filling containers, such as bottles, cups, ampoules or the like, with a defined quantity of a medium, in particular one that is at least partially or predominantly liquid. The medium can be practically any flowable, dispensable substance, such as a low-viscosity or pasty liquid or, for example, a granulate or powder. The carousel filling machine RF comprises a carousel K, in this case designed as a rotor, on which a plurality of filling stations A1, A2, . . . , An, which are substantially identical in design and function, are arranged evenly distributed along a circumference. During operation of the carousel filling machine, when the carousel K is driven, the filling stations rotate about a central axis of rotation DA on an orbit, in this case a circular orbit, defined by the carousel K and the arrangement of the corresponding filling stations at an angular speed which is kept substantially constant at least over a period of several revolutions. The containers to be filled are transferred to the carousel K or to the assigned filling station in a suitable sequential manner via a feed system formed, for example, by a conveyor belt and a so-called infeed starwheel. Each of the containers is filled during a filling phase marking the actual filling process of the corresponding filling point, while the medium is allowed to flow into the assigned container until a predefined filling quantity is reached. After completion of the particular filling phase, each of the containers is taken over by a discharge system formed, for example, by means of a so-called discharge starwheel and a discharge conveyor belt, possibly already suitably sealed, and transferred to the next station for further treatment. In the embodiment shown here, the carousel filling machine has 17 such filling points A1-An, which are moved about the axis of rotation DA, each with a magnetic-inductive flow measurement device of the carousel filling machine and a container FL which is placed therebelow to be filled presently.

The carousel filling machine RF, in particular also the speed at which the filling points are moved about the axis of rotation DA, and/or the respective starting times at which the individual filling phases of the filling points are started and, associated therewith, also the respective starting times at which the measurement phases of the particular associated magnetic-inductive flow measurement device are started, is controlled and/or monitored in accordance with one embodiment of the invention using a higher level control electronics PLC which processes measured values and is designed, for example, as a programmable logic controller. The, for example, modular, control electronics PLC can be arranged, at least in part, on the carousel K and, at least in part, outside it. For the purpose of controlling and/or monitoring the individual filling points, the control electronics PLC is advantageously also electrically connected to the particular magnetic-inductive flow measurement device electronics of the filling points via corresponding signal lines SL, optionally also with the interposition of corresponding slip ring contacts. Alternatively or in addition, the control electronics PLC and magnetic-inductive flow measurement device electronics can also communicate with each other wirelessly by radio. In addition, it can also be advantageous for fast and precise control of the filling processes if the magnetic-inductive flow measurement device electronics also send control commands (wirelessly by radio and/or wired) directly to the at least one valve of the assigned filling point. To improve the accuracy as well as the dynamics of the carousel filling machine control, according to a further embodiment of the invention, the control electronics PLC is connected to a rotation rate sensor DS, which in the exemplary embodiment shown is arranged at the edge of the rotary table DT, and which detects the rotary movement of the carousel K, for example, optically or inductively, and which recurrently generates a speed value, in particular a digital speed value, representing a currently measured speed of the carousel and makes it available to the control electronics PLC. According to an advantageous embodiment of the invention, the magnetic-inductive flow measurement device electronics MW1 is also designed so that it can be connected to a field bus system and thus integrated into a higher-level electronic data transmission and data processing system, for example, a programmable logic controller controlling the carousel filling machine or a cross-system process control system PL.

FIG. 9 is a representation of an embodiment of the method sequence according to the invention. The method comprises the following method steps:
applying an operating signal having a variable (coil) voltage and a variable (coil) current to the device for generating the magnetic field for feeding electrical power into the device (5) for generating the magnetic field.

The voltage signal has a voltage curve which is variable over time and is divided into time intervals. Said time intervals each have a first time subinterval t_{hold}, in which a first (coil) voltage U_{hold}, which is in particular constant over the, in particular entire, first time subinterval t_{hold}, is applied to the coil device.
controlling the first (coil) voltage U_{hold} in such a way that a difference between a control function and the control setpoint value is minimal.

In a further embodiment, the operating signal can be designed as shown in FIGS. 4 and 5 and the associated description of the figures.

1-34. (canceled)

35. A magnetic-inductive flow measurement device for determining a flow rate-dependent measured variable for a flowable medium, the flow measurement device comprising:
a magnetic field-generating device configured to generate a magnetic field and including a coil arrangement;
a voltage measuring device configured to enable tapping a measurement voltage induced in the flowable medium and including at least two diametrically arranged measuring electrodes;
an operating circuit configured to supply electrical power into the magnetic field-generating device via an electrical operating signal, which includes a variable coil voltage and a variable coil current,
wherein the operating signal defines a time-varying voltage curve, which is divided into time intervals,
wherein the time intervals each include a first time subinterval in which the coil voltage assumes a first voltage, which is constant over the first time subinterval; and
a controller circuit including a microprocessor,
wherein the controller circuit is configured to control at least the first voltage such that a difference between a control function and a predetermined control setpoint value is minimal, wherein the control setpoint value includes a variable proportional to a magnetic flux.

36. The flow measurement device according to claim 35, wherein:
each time interval includes a second time subinterval, during which the coil voltage assumes a second voltage, which is applied to the magnetic field-generating device and is constant over the second time subinterval;
the second voltage is greater than the first voltage; and
the first voltage and the duration of the second time subinterval are each a changeable and controllable variable.

37. The flow measurement device according to claim 36, wherein the control function depends on a product of the duration of the second time subinterval and a voltage function dependent on the first voltage.

38. The flow measurement device according to claim 37, wherein an absolute value of a quotient of the first voltage and the second voltage is constant over the voltage curve, and
wherein the voltage function is inversely proportional to the duration of the second time subinterval.

39. The flow measurement device according to claim 36, wherein an absolute value of the second voltage is constant over the time intervals.

40. The flow measurement device according to claim 35, wherein the coil current assumes, in each time interval, a maximum current value, and
wherein a quotient of the maximum current value and a coil current value determined during the first time subinterval is constant over the operating signal.

41. The flow measurement device according to claim 37, wherein the coil current assumes, in each time interval, a maximum current value, and
wherein the voltage function further depends on the maximum current value.

42. The flow measurement device according to claim 37, wherein the voltage function is proportional to:
$$ln ( ( {U}_{shot} + {U}_{h o l d} ) / ( {U}_{s h o t} - {U}_{h o l d} ) ) ,$$
wherein U_{hold} is the first voltage, and Uₛₕₒₜ is the second voltage.

43. The flow measurement device according to claim 35,
wherein the control function depends on a product of a duration of a rise time subinterval and a function dependent on the first voltage, and
wherein an absolute value of the coil current rises from a first current setpoint value to a second current setpoint value within the rise time subinterval.

44. The flow measurement device according to claim 37, wherein the coil current, in each time interval, assumes a maximum current value,
wherein the control function depends on a product of a duration of a third time subinterval and the voltage function, and
wherein the third time subinterval is limited by a start of the second time subinterval and a point in time at which the coil current assumes the respective maximum current value.

45. The flow measurement device according to claim 35, wherein a sign of the voltage curve alternates in consecutive time intervals.

46. The flow measurement device according to claim 45, wherein time intervals with a positive sign in the voltage curve have a first control setpoint value, and time intervals with a negative sign have a second control setpoint value,
wherein the first control setpoint differs from the second control setpoint.

47. The flow measurement device according to claim 35, wherein the control function depends on a product of a coil current value of the coil current during a measurement interval and an apparent self-inductance value.

48. The flow measurement device according to claim 35, wherein the flow measurement device is configured as a magnetic-inductive flowmeter, comprising a measuring tube operable for conducting the flowable medium.

49. The flow measurement device according to claim 35, wherein the flow measurement device is configured as a magnetic-inductive flow measuring probe, which is configured to be introduced into a lateral opening of a pipeline, comprising a housing to be supplied with the medium.

50. The flow measurement device according to claim 35, wherein the coil current is less than or equal to 750 mA.

51. The flow measurement device according to claim 35, wherein the coil current is less than or equal to 30 mA.

52. The flow measurement device according to claim 35, wherein the operating circuit is operated by a galvanic cell.

53. A method for operating a magnetic-inductive flow measurement device for determining a flow rate-dependent measured variable of a flowable medium, wherein the flow measurement device comprises a device for generating a magnetic field and a device for tapping a measurement voltage in the medium, the method comprising:
applying an operating signal having a variable coil voltage and a variable coil current to the device for generating the magnetic field for supplying electrical power to the device for generating the magnetic field,
wherein the operating signal defines a time-varying voltage curve, which is divided into time intervals,
wherein the time intervals each have a first time subinterval, in which a first voltage, which is constant over the first time subinterval, is applied to the device for generating the magnetic field;
controlling the first voltage such that a difference between a control function and a control setpoint value is minimal.

54. The method according to claim 53, wherein:
each time interval includes a second time subinterval, in which a second voltage, which is constant over the second time subinterval, is applied to the device for generating the magnetic field;
the second voltage is greater than the first voltage;
a duration of the second time subinterval and the first voltage are each a changeable and controllable variable; and
the control function depends on a product of the duration of the second time subinterval and a function dependent on the first voltage.

55. The method according to claim 54, wherein an absolute value of a quotient of the first voltage and the second voltage is constant over the voltage curve, and
wherein the function dependent on the first voltage is inversely proportional to the duration of the second time subinterval.

56. The method according to claim 54, wherein an absolute value of the second voltage is constant over the time intervals.

57. The method according to claim 53, wherein the coil current in each case assumes a maximum coil current value in the time intervals, and
wherein a condition is fulfilled that a quotient of the maximum coil current value and a coil current value determined during the first time subinterval is constant over the operating signal.

58. The method according to claim 54, wherein the coil current in each case assumes a maximum current value in the time intervals, and
wherein the function dependent on the first voltage further depends on the maximum current value.

59. The method according to claim 54, wherein the function dependent on the first voltage further depends on:
$$ln ( ( {U}_{shot} + {U}_{h o l d} ) / ( {U}_{s h o t} - {U}_{h o l d} ) ) ,$$
wherein U_{hold} is the first voltage, and Uₛₕₒₜ is the second voltage.

60. The method according to claim 53, wherein the control function depends on a product of a duration of a rise time subinterval and a function dependent on the first voltage, and
wherein an absolute value of the coil current rises from a first current setpoint value to a second current setpoint value within the rise time subinterval.

61. The method according to claim 54, wherein:
the coil current in each time interval assumes a maximum coil current value;
the control function depends on a product of a duration of a third time subinterval and the function dependent on the first voltage; and
the third time subinterval is limited by the start of the second time subinterval and a point in time at which the coil current assumes the respective maximum coil current value.

62. The method according to claim 53, wherein a sign of the voltage curve alternates in consecutive time intervals.

63. The method according to claim 53, wherein time intervals with a positive sign in the voltage curve have a first control setpoint value, and time intervals with a negative sign have a second control setpoint value,
wherein the first control setpoint differs from the second control setpoint.

64. The method according to claim 53, wherein the control function depends on a product of a coil current value of the coil current during a measurement interval and an apparent self-inductance value.

65. A method for determining a flow rate-dependent measured variable of a flowable medium using a magnetic-inductive flow measurement device, wherein the magnetic-inductive flowmeter comprises a device for generating a magnetic field and a device for tapping a measurement voltage in the medium, the method comprising:
performing the method of claim 53 in a process such that requirements of OIML R-49 (2013), EN1434-4 (2018) or DIRECTIVE 2014/32/EU (2014) for fulfilled.

66. The method according to claim 65, wherein the flow measurement device includes a housing, which includes a plastic or aluminum casing, or which is formed exclusively with a plastic housing body.

67. The method according to claim 65, wherein the flow measurement device does not include a shielding plate within a housing thereof and/or is arranged without shielding with respect to an external magnetic field-generating device.

68. A method of operating the magnetic-inductive flow measurement device according to claim 35, the method comprising:
determining a flow rate-dependent measured variable for a flowable medium,
wherein the magnetic-inductive flow measurement device is exposed to a magnetic field of greater than or equal to 0.3 G, in particular between 1.25 and 90 G.

69. The method according to claim 68, wherein the flow rate-dependent measured variable is determined for monitoring a process of a smelting furnace or a desalination plant.

70. The method according to claim 68, wherein the flow measurement device does not include a shielding plate within a housing thereof and/or is arranged without shielding with respect to an external magnetic field-generating device.

71. A method of operating the magnetic-inductive flow measurement device according to claim 35, the method comprising:
determining a flow rate-dependent measured variable for a flowable medium for each of a plurality of filing stations in a rotary carousel filling machine, which includes the plurality of filing stations,
wherein the rotary carousel filling machine includes a plurality of the magnetic-inductive flow measurement devices, each configured to determine the measured variable at at least one of the plurality of filling stations.

72. The method according to claim 68, wherein the plurality of magnetic-inductive flow measurement devices do not have a shielding plate within a housing thereof and/or are arranged without shielding with respect to an external magnetic field-generating device.
